(19) United States
(12) Patent Application Publication
(10) Pub. No.: US 2011/0158557 A1
(43) Pub. Date: Jun. 30, 2011

(54) IMAGE SERVER AND IMAGE TRANSMISSION METHOD THEREOF

(75) Inventor: CHI-SHENG GE, Tu-Cheng (TW)

(73) Assignee: HON HAI PRECISION INDUSTRY CO., LTD., Tu-Cheng (TW)

(21) Appl. No.: 12/859,276

(22) Filed: Aug. 19, 2010

(30) Foreign Application Priority Data
Dec. 24, 2009 (CN) 200910312206.7

(51) Int. Cl. G06K 9/54

(52) U.S. Cl. 382/305

(57) ABSTRACT

An image server including a storage unit and a processing unit is disclosed. The storage unit stores at least one image and sub-images corresponding to each image. Each sub-image is assigned with a priority value. The processing unit includes an image searching module, an order determining module, and an image transmitting module. The image searching module is configured to search the sub-images of an image in the storage unit responding to a request for images from a terminal device. The order determining module is configured to determine an order of transmitting the searched sub-images according to the priority value of each of the searched sub-images. The image transmitting module is configured to transmit the searched sub-images in the predetermined order to the terminal device via a network.

### BACKGROUND

1. Technical Field

The present disclosure relates to image servers and image transmission methods thereof.

2. Description of the Related Art

Anyone who has navigated the worldwide web to browse images is aware that the images are displayed from the top to the bottom on the webpage, this is especially obvious when trying to view images of a large size. Because of this, some important parts of the images may be displayed last, users need to wait for the image to load before they can choose whether to close the webpage. When the network is busy or if the user has slower Internet connections, it can be very time consuming to wait until the entire images are loaded completely.

### BRIEF DESCRIPTION OF THE DRAWINGS

The components of the drawings are not necessarily drawn to scale, the emphasis instead being placed upon clearly illustrating the principles of an image server and an image transmission method thereof. Moreover, in the drawings, like reference numerals designate corresponding parts throughout several views.

FIG. 1 is a schematic view of an image display system according to an exemplary embodiment.

FIG. 2 is a block diagram view of an image server of the image display system of FIG. 1.

FIG. 3 is a schematic view of an image.

FIG. 4 shows that the image of FIG. 3 is divided into 16 sub-images each with a priority value.

FIG. 5 is a flowchart of an image transmission method according to an exemplary embodiment.

### DETAILED DESCRIPTION

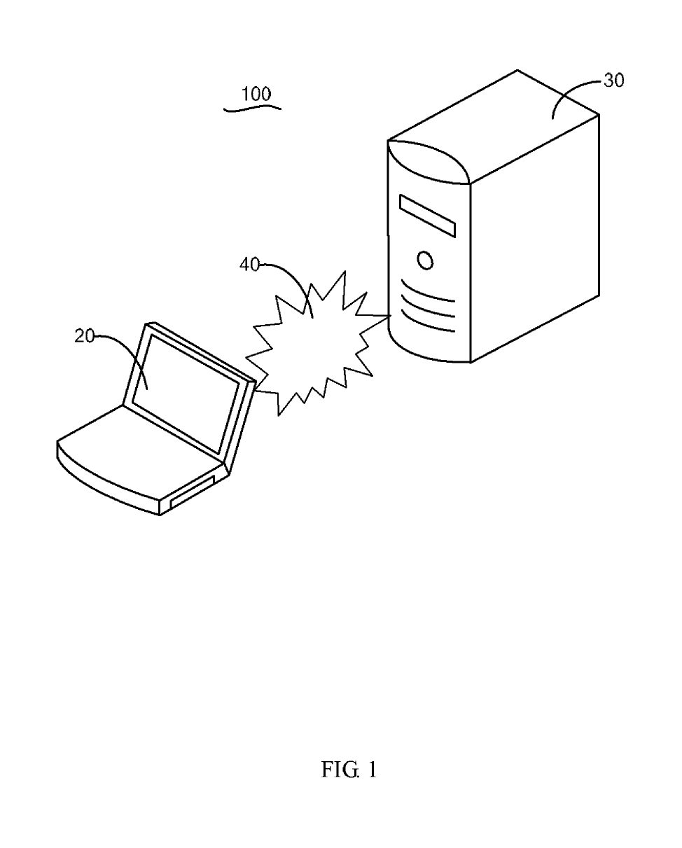

Referring to FIG. 1, an image display system 100 includes an image server 30 and at least one terminal device 20, e.g. a notebook computer, connected to the image server 30 via a network 40.

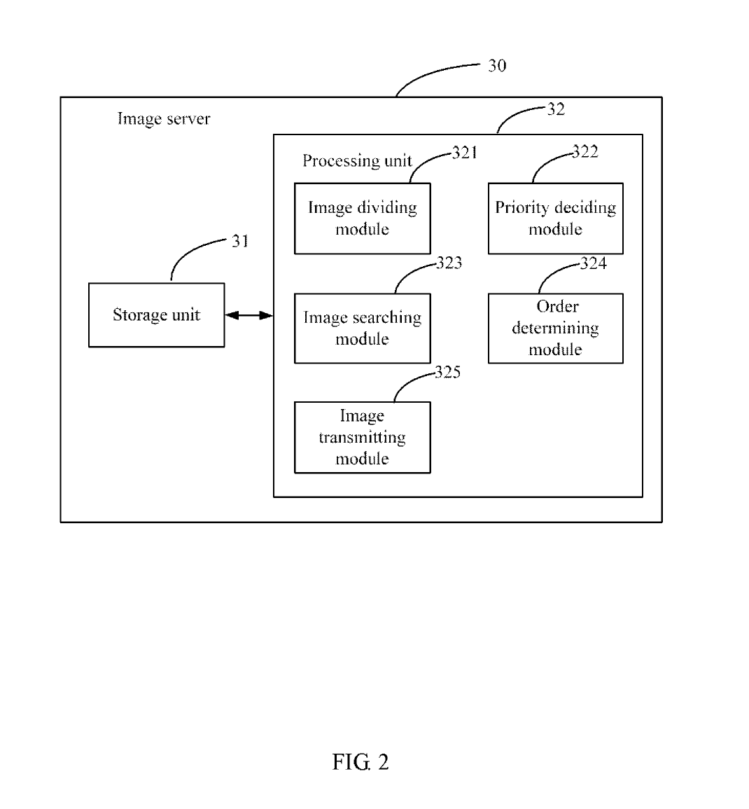

Referring to FIG. 2, the image server 30 includes a storage unit 31 and a processing unit 32.

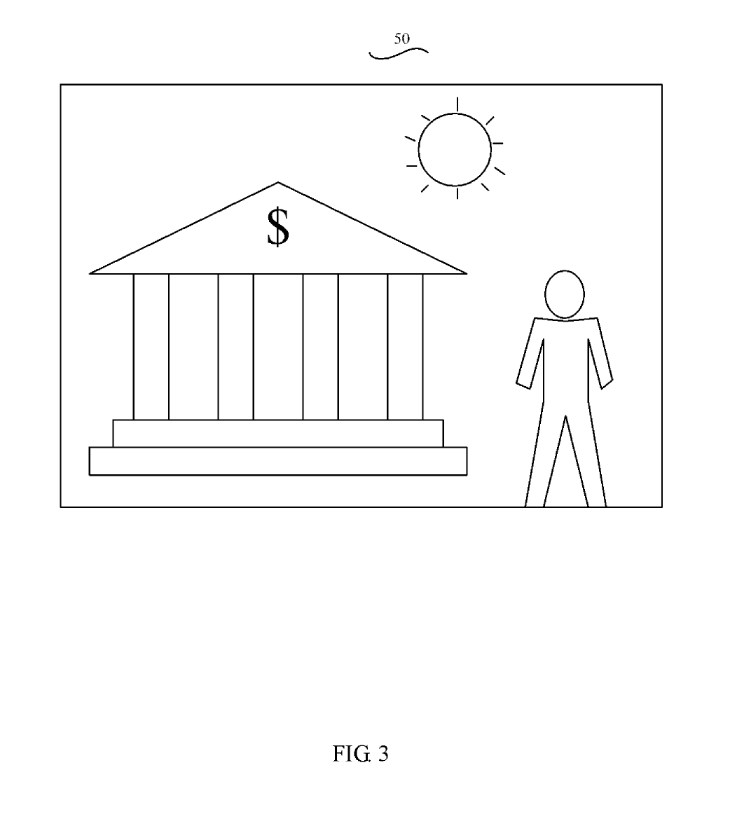

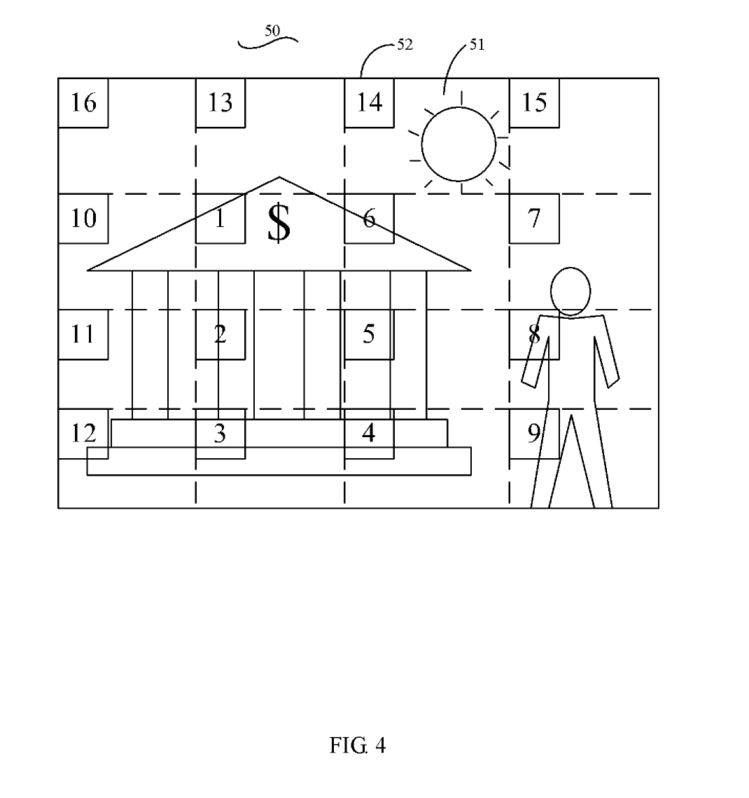

The storage unit 31 stores at least one image and a number of sub-images corresponding to each image. In the embodiment, each image is divided into a number of sub-images. Each sub-image is assigned with a priority value and a position identifier. The priority values of the sub-images corresponding to one image are employed to define an order of transmitting the sub-images to the terminal device 20. In this embodiment, the more important part of one image is assigned with a smaller priority value. As shown in FIGS. 3-4, an image 50 is evenly divided into sixteen sub-images 51 each assigned with a priority value 52. In the embodiment, the sub-image 51 of which the priority value 52 is “1” is transmitted first to the terminal device 20, and that of which the priority value 52 is “16” is transmitted last to the terminal device 20. The position identifier of each of the sub-images corresponding to one image is employed to determine where each of the sub-images is displayed on an associated webpage.

The processing unit 32 includes an image dividing module 321, a priority deciding module 322, an image searching module 323, an order determining module 324, and an image transmitting module 325.

The image dividing module 321 is configured to divide an image into a number of sub-images in response to input command and assign one position identifier to each sub-image to indicate where each sub-image is displayed.

The priority deciding module 322 is configured to assign one priority value to each sub-image in response to input command.

The image searching module 323 is configured to search the sub-images of an image in the storage unit 31 responding to a request for images from the terminal device 20.

The order determining module 324 is configured to determine an order to transmit the sub-images according to the priority value of each sub-image.

The image transmitting module 325 is configured to transmit the sub-images in the predetermined order to the terminal device 20 through the network 40. The terminal device 20 then displays the sub-images in sequence according to the position identifiers of the sub-images similar to any conventional way.

With such configuration, the image server 30 first transmits an important part of the image to the terminal device 20, thus users can quickly determine whether the image is needed.

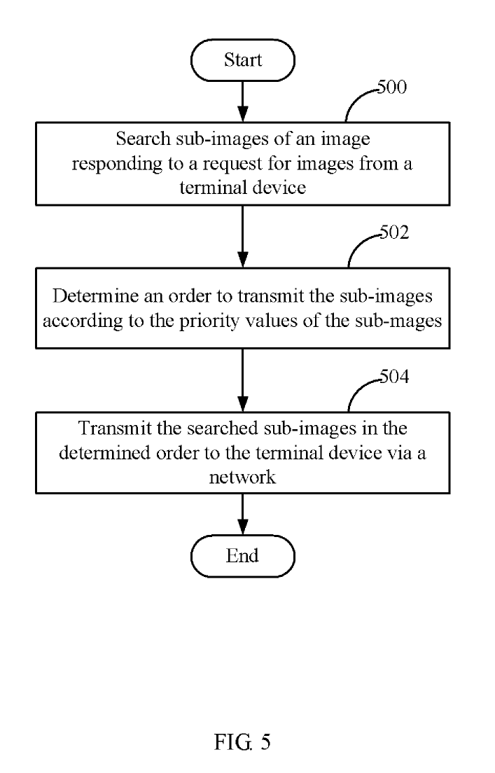

Referring to FIG. 5, a flowchart of an image transmission method is illustrated.

In step 500, the image searching module 323 searches the sub-images of an image in the storage unit 31 responding to a request for images from the terminal device.

In step 502, the order determining module 324 determines an order to transmit the sub-images according to the priority values of the sub-mages.

In step 504, the image transmitting module 325 transmits the sub-images in the predetermined order to the terminal device 20.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. An image server comprising:
a storage unit storing at least one image and sub-images corresponding to each of the at least one image, wherein each of the sub-images is assigned with a priority value; and
a processing unit comprising:
an image searching module configured to search the sub-images of one of the at least one image responding to a request for images from a terminal device;
an order determining module configured to determine an order of transmitting the searched sub-images according to the priority value of each of the searched sub-images; and
an image transmitting module configured to transmit the searched sub-images in the predetermined order to the terminal device via a network.

2. The image server as described in claim 1, wherein the processing unit further comprises a priority deciding module configured to assign one priority value to each of the sub-images.

3. The image server as described in claim 1, wherein the processing unit further comprises an image dividing module configured to divide each of the at least one image into a plurality of sub-images in response to input command and assign a position identifier to each of the sub-images to indicate where each of the sub-images is displayed.

4. An image transmission method comprising:
searching sub-images of an image responding to a request for images from a terminal device;
determining an order to transmit the sub-images according to the priority values of the sub-mages; and
transmitting the searched sub-images in a determined order to the terminal device via a network.

5. The image transmission method as described in claim 4, wherein each of the sub-images is further assigned with a position identifier to indicate where each of the sub-images is displayed.
